(19) United States
(12) Patent Application Publication
(10) Pub. No.: US 2005/0184533 A1
(43) Pub. Date: Aug. 25, 2005

(54) Shape memory alloy-actuated release mechanisms for drive systems

(76) Inventors: Joseph J. Hebenstreit, San Francisco, CA (US); Roderick MacGregor, Antioch, CA (US)

Correspondence Address: DORITY & MANNING, P.A., POST OFFICE BOX 1449, GREENVILLE, SC, 29602-1449, US

(21) Appl. No.: 10/871,357

(22) Filed: Jun. 18, 2004

Related U.S. Application Data
(60) Provisional application No. 60/480,058, filed on Jun. 20, 2003.

(51) Int. Cl. F16H 21/00

(52) U.S. Cl. 292/201

(57) ABSTRACT

Embodiments of the invention relate to shape memory alloy (“SMA”)-actuated release mechanisms for drive systems. In one embodiment, a SMA-actuated release mechanism includes at least one anchor point and a pivot point. The SMA-actuated release mechanism also includes a latch member pivotally coupled to the pivot point and configured to engage a drive member of a drive system. The SMA=actuated release mechanism further includes a SMA element having a first portion coupled to the least one anchor point and a second portion coupled to the latch member. Activation of the SMA element causes the latch member to pivot about the pivot point, such that the latch member disengages from the drive member.

### CROSS REFERENCE TO RELATED APPLICATION

This application claims benefit under 35 U.S.C. 119(e) of U.S. Provisional Patent Application No. 60/480,058, filed on Jun. 20, 2003 and entitled “SMA Actuated Release Mechanism,” the disclosure of which is incorporated herein by reference in its entirety.

### FIELD OF THE INVENTION

The invention relates generally to drive systems. More particularly, the invention relates to shape memory alloy (“SMA”)-actuated release mechanisms for drive systems.

### BACKGROUND OF THE INVENTION

A conventional drive system typically includes a number of components that operate in conjunction to impart motion to a load. In particular, the drive system can include a drive mechanism, which can operate by converting electrical energy, mechanical energy, or some other type of energy into mechanical energy. For example, the drive mechanism can include a motor, such as an electricity-powered motor or a spring-powered motor. The drive mechanism can also include a power converter, which can be coupled to the motor via one drive member, such as an input shaft, and to the load via another drive member, such as an output shaft. The power converter can operate to adjust or vary the torque at the output shaft relative to the torque at the input shaft. For example, the power converter can include a gear assembly, and this gear assembly can transfer rotation of the input shaft at one rate into rotation of the output shaft at a different rate. Desirably, the drive system can also include a control mechanism, which can be coupled to the drive mechanism and can operate to restrain and to allow motion imparted by the drive mechanism. For example, the control mechanism can include a release mechanism, which can be coupled to the output shaft and can operate to restrain rotation of the output shaft until the release mechanism is triggered. Once triggered, the release mechanism can allow rotation of the output shaft, which, in turn, can allow motion to be imparted to the load.

Efforts continue to miniaturize drive systems, such that these drive systems can be included in increasingly smaller devices, such as certain toys. Although various components of these drive systems have been successfully miniaturized, release mechanisms of these drive systems typically have not experienced similar successes in terms of reductions in size. For example, conventional release mechanisms can be relatively bulky, thus presenting a significant obstacle towards further miniaturization of drive systems. Moreover, conventional release mechanisms sometimes require manual contact or other direct external stimulus to trigger these release mechanisms. While some remotely-triggered release mechanisms are available, these release mechanisms are often relatively bulky and over-engineered.

In view of the foregoing, what is needed is an improved release mechanism for a drive system to overcome these and other drawbacks of conventional release mechanisms.

### SUMMARY OF THE INVENTION

In one aspect, the invention relates to a SMA-actuated release mechanism for a drive system. In one embodiment, the SMA-actuated release mechanism includes at least one anchor point and a pivot point. The SMA-actuated release mechanism also includes a latch member pivotally coupled to the pivot point and configured to engage a drive member of the drive system. The SMA-actuated release mechanism further includes a SMA element having a first portion coupled to the at least one anchor point and a second portion coupled to the latch member. Activation of the SMA element causes the latch member to pivot about the pivot point, such that the latch member disengages from the drive member.

In another aspect, the invention relates to a drive system that includes a SMA-actuated release mechanism. In a further aspect, the invention relates to a method of operating a drive system that includes a SMA-actuated release mechanism.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

The invention is more fully appreciated in connection with the following detailed description taken in conjunction with the accompanying drawings, in which:

FIG. 1 illustrates a drive system that can be implemented according to one embodiment of the invention;

FIG. 2, FIG. 3, and FIG. 4 illustrate various configurations of the drive system of FIG. 1;

FIG. 5 illustrates a drive system that can be implemented according to another embodiment of the invention; and

FIG. 6, FIG. 7, FIG. 8, and FIG. 9 illustrate various configurations of the drive system of FIG. 5.

Like reference numerals refer to corresponding elements throughout the several views of the drawings.

### DETAILED DESCRIPTION

Embodiments of the invention relate to SMA-actuated release mechanisms for drive systems. According to some embodiments of the invention, a SMA-actuated release mechanism can be coupled to a drive mechanism and can operate to restrain and to allow motion imparted by the drive mechanism. Advantageously, a SMA-actuated release mechanism according to some embodiments of the invention can be formed with a relatively compact size, thus facilitating miniaturization of a drive system that includes the SMA-actuated release mechanism. Also, a SMA-actuated release mechanism according to some embodiments of the invention can be triggered remotely, thus allowing remote activation of a drive system that includes the SMA-actuated release mechanism. Moreover, a SMA-actuated release mechanism according to some embodiments of the invention can include a reliability-enhancing coupling mechanism to reduce the amount of time that a SMA actuator remains activated, thus increasing the life expectancy of the SMA actuator.

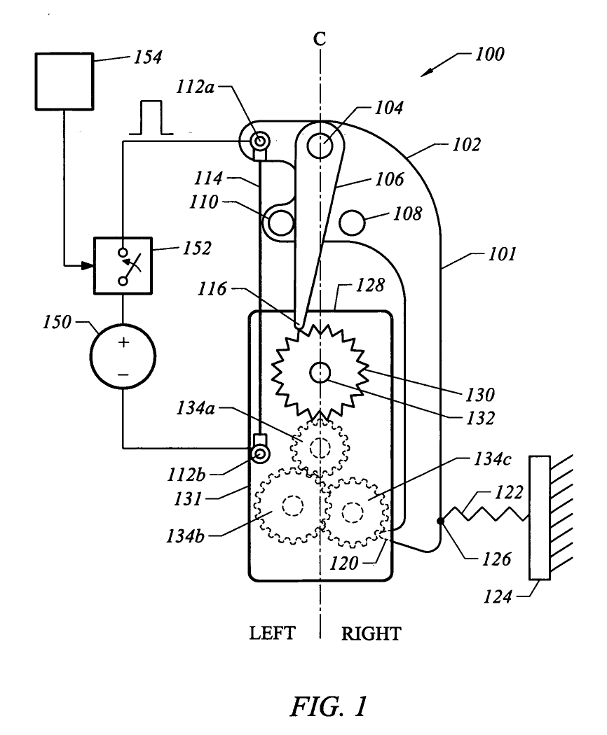

FIG. 1 illustrates a drive system 100 that can be implemented according to one embodiment of the invention. The drive system 100 includes a drive mechanism 128 and a SMA-actuated release mechanism 101 that is coupled to the drive mechanism 128. In the illustrated embodiment, elements having reference numbers 130 to 134c constitute the drive mechanism 128, while elements having reference numbers 102 to 126 and 150 to 154 constitute the SMA-actuated release mechanism 101.

As illustrated in FIG. 1, the drive mechanism 128 includes a gearbox 131 that includes a gear assembly, which is illustrated conceptually as gears 134a, 134b, and 134c. In the illustrated embodiment, the gearbox 131 is a windup gearbox that can be coupled to a spring-powered motor (not illustrated) via a drive member (not illustrated), such as an input shaft. Such windup gearbox and spring-powered motor can be implemented in a conventional fashion and need not be discussed in detail. For example, the spring-powered motor can include a drive spring that can be wound by an external stimulus via a winding knob. Mechanical energy that is stored in the wound drive spring can then be used to drive the gear assembly of the gearbox 131. One application of such windup gearbox and spring-powered motor is for powering toys. In the illustrated embodiment, the gearbox 131 is coupled to a drive member 132, such as an output shaft, which is coupled to an activation gear 130.

In the illustrated embodiment, the SMA-actuated release mechanism 101 is configured to releasably engage the drive mechanism 128 to restrain and to allow motion imparted by the drive mechanism 128. As illustrated in FIG. 1, the SMA-actuated release mechanism 101 includes a latch member 102 and a rocker arm member 106 that is pivotally coupled to the latch member 102. The latch member 102 has one portion at which a pin 104 couples the latch member 102 to the rocker arm member 106, and the latch member 102 is configured to pivot about the pin 104. The latch member 102 has another portion that is formed as a pawl 120, which is configured to engage the gear 134c. The rocker arm member 106 has one portion at which the pin 104 couples the rocker arm member 106 to the latch member 102, and the rocker arm member 106 is configured to pivot about the pin 104. In the illustrated embodiment, the rocker arm member 106 is configured to pivot about the pin 104 in an arc angularly limited by bosses 108 and 110. The bosses 108 and 110 are formed as projections that extend from a surface of the latch member 102 and are configured to limit movement of the rocker arm member 106 as well as to transfer forces between the rocker arm member 106 and the latch member 102. The rocker arm member 106 has another portion that is formed as a rocker arm member tip 116, which is configured to engage the activation gear 130. In the illustrated embodiment, the SMA-actuated release mechanism 101 also includes a bias spring 122 having one portion that is coupled to the latch member 102 at an attachment point 126. The bias spring 122 has another portion that is coupled to a stationary fixture 124.

As illustrated in FIG. 1, the SMA-actuated release mechanism 101 also includes a SMA actuator 114 that is coupled between connection points 112a and 112b, which are anchored with respect to the latch member 102 and the gearbox 131, respectively. While the connection point 112b is illustrated as being anchored with respect to the gearbox 131, it is contemplated that the connection point 112b can be anchored with respect to another component, such as one having a fixed spatial relationship with respect to the gearbox 131. For certain applications, the connection points 112a and 112b can be electrically isolated from the latch member 102 and the gearbox 131, respectively. As illustrated in FIG. 1, the SMA actuator 114 includes at least one SMA element.

A SMA element refers to a SMA material that has an elongate form and that is capable of contraction and elongation along a longitudinal axis. Advantageously, a SMA element can have a relatively slender form. As a result, the SMA-actuated release mechanism 101 can be formed with a relatively compact size, thus facilitating miniaturization of the drive system 100 that includes the SMA-actuated release mechanism 101. A SMA element can have a circular cross-section, as is the case for a SMA wire, or any of various other geometric and non-geometric cross-sections, such as elliptical, square, rectangular, and so forth. Examples of SMA materials include those that exhibit two distinctive properties, namely pseudo-elasticity and shape memory effect. Pseudo-elasticity refers to an almost rubber-like flexibility exhibited by a SMA material, while shape memory effect refers to the ability of a SMA material to be substantially deformed upon activation and to substantially return to its original shape subsequent to activation. Activation of a SMA element is typically performed based on electric or ohmic heating in which an electric current is passed through the SMA element. However, it is contemplated that any of various other activation techniques can be used. Specific examples of SMA materials include metals such as NiTi, CuZnAl, CuAlNi, and so forth.

In the illustrated embodiment, the SMA-actuated release mechanism 101 also includes a power generator 150, a controller 152, and a sensor 154, which are coupled to the connection points 112a and 112b. Upon the sensor 154 detecting an external stimulus to trigger the SMA-actuated release mechanism 101, the sensor 154 provides a control signal to the controller 152. In the illustrated embodiment, the sensor 154 is configured to detect a radio signal, an infrared signal, an acoustic signal, or any other external stimulus that allows remote activation of the drive system 100. However, it is contemplated that the sensor 154 can be configured to detect an external stimulus that is non-remotely applied, such as via a human hand. In response to the control signal from the sensor 154, the controller 152 activates the power generator 150 to pass an electric current through the SMA actuator 114, which electric current can have a predetermined pulse duration of, for example, a second or a fraction of a second. The power generator 150, the controller 152, and the sensor 154 can be implemented in a conventional fashion and need not be discuss in detail. For example, the controller 152 can be implemented using computer code, hardwired circuitry, such as Application-Specific Integrated Circuits (“ASICs”) or Programmable Logic Devices (“PLDs”), or a combination of computer code and hardwired circuitry. The power generator 150 can be implemented using any voltage source, such as a button-cell battery.

As illustrated in FIG. 1, the drive mechanism 128 has already been wound by an external stimulus, such as via a human hand. The SMA-actuated release mechanism 101 is initially in a “locked” configuration, such that the latch member 102 engages the gear assembly of the gearbox 131 to restrain unwinding of the gear assembly. In particular, the bias spring 122 applies a biasing force to the latch member 102 at the attachment point 126, such that the pawl 120 engages the gear 134c to substantially immobilize the gear 134c. In turn, such engagement of the pawl 120 with the gear 134c substantially immobilizes the gears 134a and 134b, the activation gear 130, and the drive member 132. Referring to FIG. 1, the rocker arm member 106 is initially oriented with respect to a center line C, such that the rocker arm member tip 116 slightly engages (or nearly engages) a portion of the activation gear 130 on the left side of the center line C. As illustrated in FIG. 1, the SMA actuator 114 is initially extended between the connection points 112a and 112b with no electric current passing through the SMA actuator 114. As such, the SMA actuator 114 is configured to contract if an electric current is subsequently passed through the SMA actuator 114.

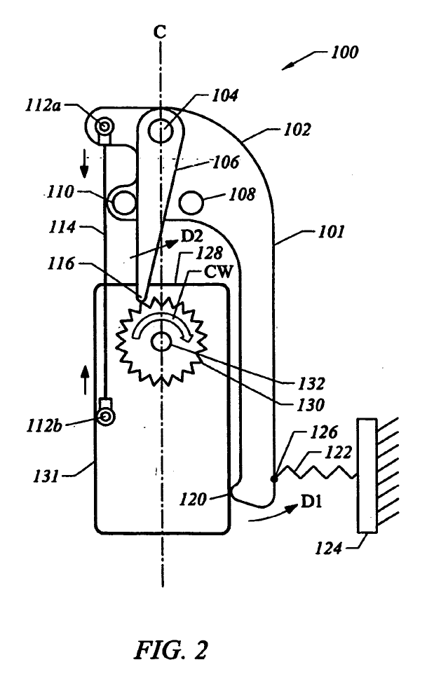

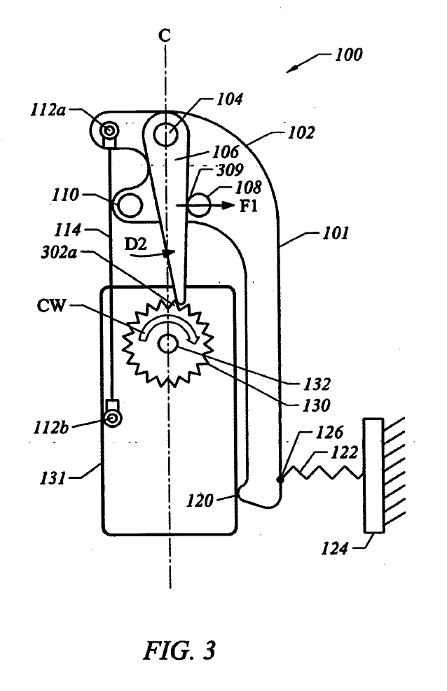

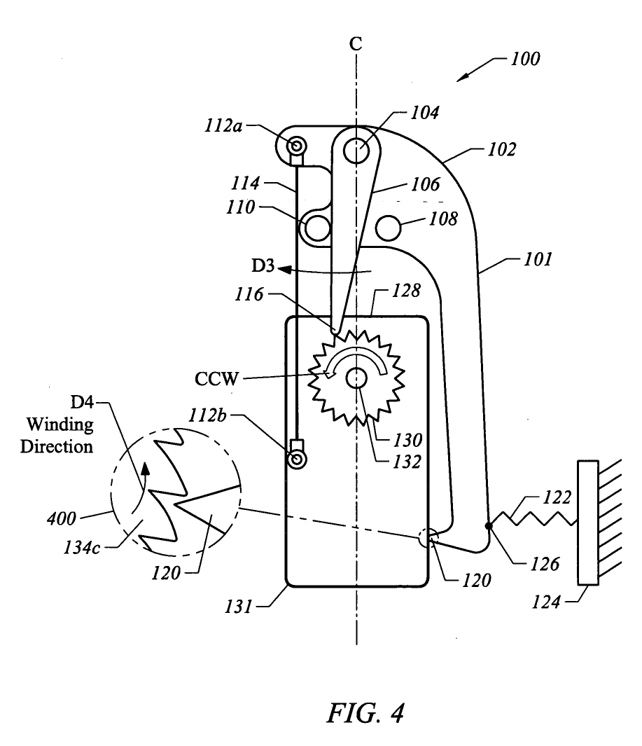

The operation of the drive system 100 can be more fully appreciated with reference to FIG. 2 through FIG. 4, which illustrate various configurations of the drive system 100 when the SMA-actuated release mechanism 101 is triggered. For ease of illustration, certain components of the drive system 100 are omitted in FIG. 2 through FIG. 4.

Attention first turns to FIG. 2, which illustrates the drive system 100 shortly after the SMA-actuated release mechanism 101 is triggered. As illustrated in FIG. 2, the SMA-actuated release mechanism 101 is now in an “unlocked” configuration, such that the latch member 102 disengages from the gear assembly of the gearbox 131 to allow unwinding of the gear assembly. In particular, as an electric current passes through the SMA actuator 114, the SMA actuator 114 contracts between the connection points 112a and 112b. Such contraction of the SMA actuator 114 causes the latch member 102 to pivot about the pin 104 along a direction D1, which, in turn, causes the pawl 120 to disengage from the gear 134c (previously illustrated in FIG. 1). In conjunction, the gear assembly of the gearbox 131 unwinds, thus causing the activation gear 130 and the drive member 132 to rotate in a clockwise direction CW. Also, since the rocker arm member tip 116 engages the activation gear 130, rotation of the activation gear 130 along the clockwise direction CW causes the rocker arm member 106 to pivot about the pin 104 along a direction D2. In the event that the rocker arm member tip 116 was not already engaging the activation gear 130, pivoting of the latch member 102 along the direction D1 causes the boss 110 to engage the rocker arm member 106, which causes the rocker arm member 106 to pivot until the rocker arm member tip 116 engages the activation gear 130. Once the rocker arm member tip 116 engages the activation gear 130, rotation of the activation gear 130 causes the rocker arm member 106 to pivot about the pin 104 as discussed above.

FIG. 3 illustrates the drive system 100 with the SMA-actuated release mechanism 101 remaining in the “unlocked” configuration. As illustrated in FIG. 3, an electric current is no longer passing through the SMA actuator 114, such that the SMA actuator 114 remains contracted but is now relaxed. Advantageously, the rocker arm member 106 engages the boss 108 at a contact point 309 so as to keep the pawl 120 disengaged from the gear 134c (previously illustrated in FIG. 1). In particular, the rocker arm member tip 116 has passed across the center line C as a result of the rocker arm member 106 pivoting along the direction D2. The gear assembly of the gearbox 131 continues to unwind, thus causing the activation gear 130 and the drive member 132 to rotate along the clockwise direction CW. As the activation gear 130 rotates along the clockwise direction CW, various teeth of the activation gear 130 apply a force to the rocker arm member tip 116, which, in turn, causes a force F1 to be applied from the rocker arm member 106 to the boss 108 at the contact point 309. As illustrated in FIG. 3, a tooth 302a pushes against the rocker arm member tip 116, thus causing the force F1 to be applied to the boss 108. Desirably, the force F1 keeps the latch member 102 from pivoting back into the “locked” configuration. During unwinding, the force F1 can decrease momentarily as the rocker arm member tip 116 slides past the tooth 302a and before the rocker arm member tip 116 engages another tooth 302b. During such time interval, the bias spring 122 can momentarily push the pawl 120 towards the gear 134c (previously illustrated in FIG. 1). However, once the rocker arm member tip 116 reengages the activation gear 130 at the tooth 302b, the force F1 is resumed to keep the pawl 120 disengaged. Advantageously, by including the rocker arm member 106 (as well as the bosses 108 and 110 and the activation gear 130), the SMA-actuated release mechanism 101 can remain in the “unlocked” configuration without having to activate the SMA actuator 114 as the gear assembly of the gearbox 131 unwinds. Accordingly, the rocker arm member 106, the bosses 108 and 110, and the activation gear 130 can be viewed as a reliability-enhancing coupling mechanism. In particular, inclusion of this coupling mechanism serves to reduce the amount of time that the SMA actuator 114 remains activated, thus increasing the life expectancy of the SMA actuator 114 and the power generator 150 (previously illustrated in FIG. 1). As with the SMA-actuated release mechanism 101 itself, this coupling mechanism can be viewed as cycling through two configurations or states, namely a “locked” configuration and an “unlocked” configuration.

An additional advantage of the SMA-actuated release mechanism 101 can be appreciated with reference to FIG. 1 through FIG. 3. In particular, the SMA-actuated release mechanism 101 is configured so as to protect the SMA actuator 114 in the event the SMA-actuated release mechanism 101 is inadvertently triggered during unwinding. During such inadvertent triggering, an electric current of limited duration passes through the SMA actuator 114, which causes the SMA actuator 114 to contract. Such contraction of the SMA actuator 114 causes the latch member 102 to pivot about the pin 104, so that the pawl 120 moves away from the gear 134c (previously illustrated in FIG. 1). As a result of the biasing force applied by the bias spring 122, the latch member 102 simply undergoes a rotational round-trip without engaging the gearbox 131. Thus, such inadvertent triggering neither overstresses the SMA actuator 114 nor affects unwinding of the gearbox 131. By contrast, inadvertent triggering of certain conventional release mechanisms can sometimes cause engagement of the release mechanisms with a gear assembly, thus causing damage to the release mechanisms as well as to the gear assembly. It is contemplated that the controller 152 (previously illustrated in FIG. 1) can be configured to prevent issuance of a pulse of an electric current shortly following a previous pulse of an electric current. In some instances, the controller 152 can be configured to impose a time delay between successive pulses that is comparable in duration to a typical unwinding time of the gearbox 131.

Attention next turns to FIG. 4, which illustrates the drive system 100 with the SMA-actuated release mechanism 101 being returned to its “locked” configuration as the gear assembly of the gearbox 131 is being wound. Winding of the gear assembly causes the activation gear 130 and the drive member 132 to rotate in a counter clockwise direction CCW. In the event that the rocker arm member tip 116 was not already engaging the activation gear 130, the biasing force applied by the bias spring 122 causes the boss 108 to engage the rocker arm member 106, which causes the rocker arm member 106 to pivot until the rocker arm member tip 116 engages the activation gear 130. Once the rocker arm member tip 116 engages the activation gear 130, rotation of the activation gear 130 along the counter clockwise direction CCW causes the rocker arm member 106 to pivot about the pin 104 along a direction D3. In particular, the rocker arm member 106 pivots along the direction D3, such that the rocker arm member tip 116 moves back across the center line C. In conjunction, the latch member 102 reengages the gear assembly of the gearbox 131 to restrain unwinding of the gear assembly. In particular, the bias spring 122 applies a biasing force to the latch member 102 at the attachment point 126, such that the pawl 120 reengages the gear 134c. Referring to the enlarged view 400 of FIG. 4, the pawl 120 and teeth of the gear 134c are configured such that winding of the gear 134c along a direction D4 is substantially unimpeded by the pawl 120.

A further advantage of the SMA-actuated release mechanism 101 can be appreciated with reference to FIG. 4. In particular, the SMA-actuated release mechanism 101 is configured so as to extend the SMA actuator 114 in preparation for its next activation cycle and to protect the SMA actuator 114 during winding. As the activation gear 130 rotates along the counter clockwise direction CCW, various teeth of the activation gear 130 push against the rocker arm member tip 116. In turn, the rocker arm member 106 applies a force to the boss 110, thus momentarily causing the latch member 102 to pivot about the pin 104. The bias spring 122 also operates to cause such pivoting of the latch member 102. Advantageously, such pivoting of the latch member 102 serves to reverse contraction of the SMA actuator 114. As a result of the engagement of the pawl 120 with the gear 134c, the latch member 102 is prevented from continuing to pivot, thus protecting the SMA actuator 114 from overstretching during winding of the gearbox 131. Once the rocker arm member 106 transfers a pulsating clockwise torque to the latch member 102 during winding, the SMA actuator 114 can still be protected form overheating and overstress by using an electric current of limited duration.

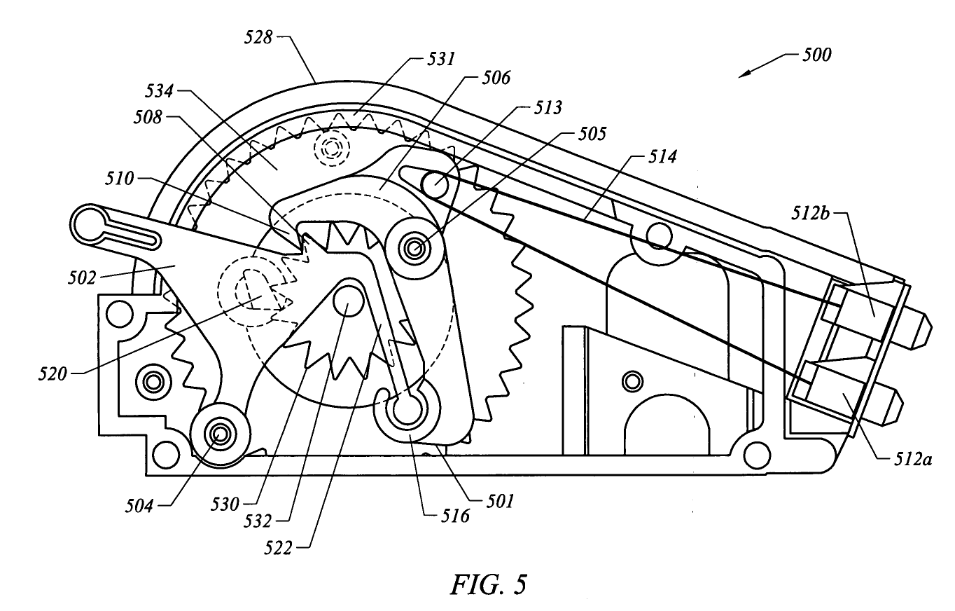

FIG. 5 illustrates a drive system 500 that can be implemented according to another embodiment of the invention. The drive system 500 includes a drive mechanism 528 and a SMA-actuated release mechanism 501 that is coupled to the drive mechanism 528. In the illustrated embodiment, elements having reference numbers 530 to 534 constitute the drive mechanism 528, while elements having reference numbers 502 to 522 constitute the SMA-actuated release mechanism 501.

As illustrated in FIG. 5, the drive mechanism 528 includes a gearbox 531 that includes a gear assembly, which is illustrated conceptually as a gear 534. In the illustrated embodiment, the gearbox 531 is a windup gearbox that can be coupled to a spring-powered motor (not illustrated) via a drive member (not illustrated), such as an input shaft. Such windup gearbox and spring-powered motor can be implemented as previously discussed in connection with FIG. 1. In the illustrated embodiment, the gearbox 531 is coupled to a drive member 532, such as an output shaft, which is coupled to an activation gear 530.

In the illustrated embodiment, the SMA-actuated release mechanism 501 is configured to releasably engage the drive mechanism 528 to restrain and to allow motion imparted by the drive mechanism 528. As illustrated in FIG. 5, the SMA-actuated release mechanism 501 is positioned above the drive mechanism 528 and includes a latch member 502 and a SMA pull member 506 that is coupled to the latch member 502. The latch member 502 has one portion at which a pin 504 couples the latch member 502 to the drive mechanism 528, and the latch member 502 is configured to pivot about the pin 504. The latch member 502 has another portion that is formed as a pawl 520, which is formed as a projection that extends below a surface of the latch member 502 and is configured to engage the activation gear 530. The latch member 502 has a further portion that is formed as a flexible arm 522, which is configured to limit movement of the SMA pull member 506 as well as to apply a biasing force to the SMA pull member 506. The SMA pull member 506 has one portion at which a pin 505 couples the SMA pull member 506 to the drive mechanism 528, and the SMA pull member 506 is configured to pivot about the pin 505. The SMA pull member 506 has another portion that is formed as an extension 510, which is configured to engage an extension 508 formed on the latch member 502. Extensions 508 and 510 are configured to limit movement of the latch member 502 and the SMA pull member 506 as well as to transfer forces between the SMA pull member 506 and the latch member 502. Advantageously, forces applied by the latch member 502 to the SMA pull member 506 can be counteracted by reaction forces from the pin 505, thus protecting the SMA actuator 514 against overstress and inadvertent and potentially damaging mechanical loads. The SMA pull member 506 has a further portion that is formed as a cup 516, which is configured to engage the flexible arm 522.

As illustrated in FIG. 5, the SMA-actuated release mechanism 501 also includes a SMA actuator 514 that is coupled between connection points 512a and 512b via a boss 513 formed on the SMA pull member 506. The connection points 512a and 512b are anchored with respect to the drive mechanism 528. As illustrated in FIG. 5, the SMA actuator 514 includes at least one SMA element. While not illustrated in FIG. 5, it is contemplated that the SMA-actuated release mechanism 501 can also include a power generator, a controller, and a sensor, which can be coupled to the connection points 512a and 512b. Such power generator, controller, and sensor can be implemented as previously discussed in connection with FIG. 1.

As illustrated in FIG. 5, the drive mechanism 528 has already been wound by an external stimulus, such as via a human hand. The SMA-actuated release mechanism 501 is initially in a “locked” configuration, such that the latch member 502 engages the activation gear 530 to restrain unwinding of the gear box 531. In particular, the pawl 520 engages the activation gear 530 to substantially immobilize the activation gear 530. In turn, such engagement of the pawl 520 with the activation gear 530 substantially immobilizes the gear 534 and the drive member 532. Referring to FIG. 5, the SMA pull member 506 is initially oriented with respect to the latch member 502, such that the extension 510 engages the extension 508 on the left side of the extension 508. Engagement of the extensions 508 and 510 serves to prevent the latch member 502 from pivoting into an “unlocked” configuration. As illustrated in FIG. 5, the SMA actuator 514 is initially extended between the connection points 512a and 512b with no electric current passing through the SMA actuator 514. As such, the SMA actuator 514 is configured to contract if an electric current is subsequently passed through the SMA actuator 514.

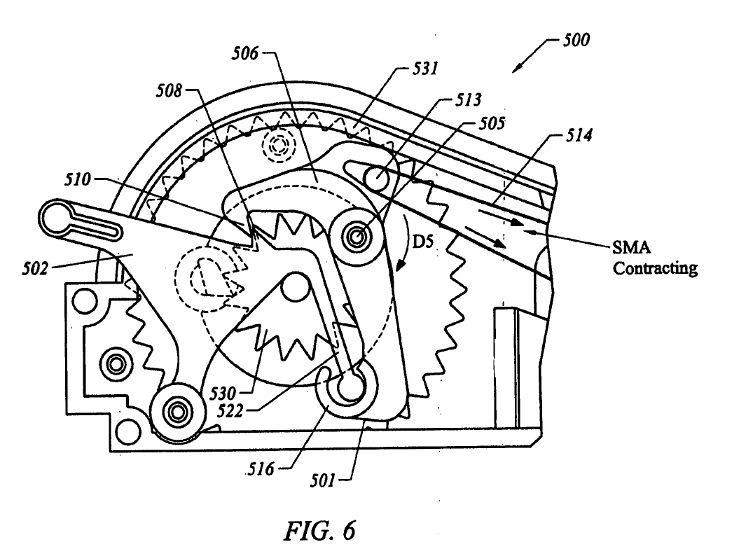

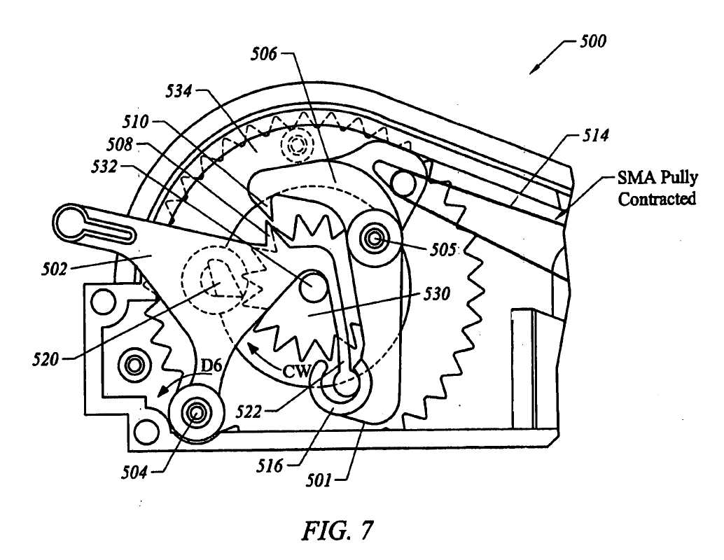

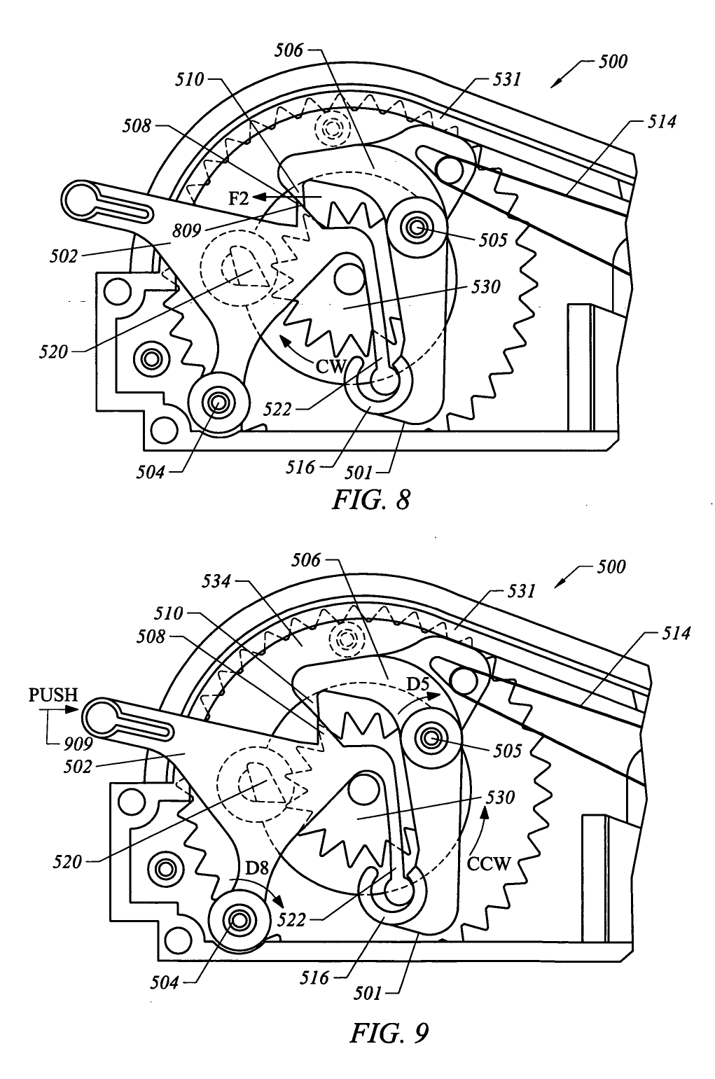

The operation of the drive system 500 can be more fully appreciated with reference to FIG. 6 through FIG. 9, which illustrate various configurations of the drive system 500 when the SMA-actuated release mechanism 501 is triggered. For ease of illustration, certain components of the drive system 500 are omitted in FIG. 6 through FIG. 9.

Attention first turns to FIG. 6, which illustrates the drive system 500 shortly after the SMA-actuated release mechanism 501 is triggered. As illustrated in FIG. 6, the SMA-actuated release mechanism 501 is still in the “locked” configuration, such that the latch member 502 continues to engage the activation gear 530 to prevent unwinding of the gearbox 531. As an electric current passes through the SMA actuator 514, the SMA actuator 514 contracts between the connection points 512a and 512b (previously illustrated in FIG. 5) at one end and the boss 513 at the other end. Such contraction of the SMA actuator 514 pulls the boss 513 towards the connection points 512a and 512b, which, in turn, causes the SMA pull member 506 to pivot about the pin 505 along a direction D5. As the SMA pull member 506 pivots along the direction D5, the cup 516 engages the flexible and 522, which causes the flexible arm 522 to bend and to store mechanical energy. Referring to FIG. 6, the SMA pull member 506 is oriented with respect to the latch member 502, such that the extension 510 still engages the extension 508 on the left side of the extension 508.

FIG. 7 illustrates the drive system 500 with the SMA-actuated release mechanism 501 in an “unlocked” configuration. In particular, the SMA actuator 514 has sufficiently contracted, such that the extension 510 disengages from the extension 508 and moves to the right side of the extension 508. Such disengagement of the extensions 508 and 510 allows unbending of the flexible arm 522, which, in turn, causes the latch member 502 to pivot about the pin 504 along a direction D6. Pivoting of the latch member 502 along the direction D6 causes the pawl 520 to disengage from the activation gear 530. In conjunction, the activation gear 530 unwinds, thus causing the gear 534 and the drive member 532 to rotate in a clockwise direction CW. As illustrated in FIG. 7, contraction of the SMA actuator 514 is reaching its greatest extent, thus allowing the SMA pull member 506 to retain its orientation and to apply a force through the cup 516 to the latch member 502.

FIG. 8 illustrates the drive system 500 with the SMA-actuated release mechanism 501 remaining in the “unlocked” configuration. As illustrated in FIG. 8, an electric current is no longer passing through the SMA actuator 514, such that the SMA actuator 514 is now relaxed. Advantageously, the extension 510 engages the extension 508 at a contact point 809 so as to keep the pawl 520 disengaged from the activation gear 530. In particular, the flexible arm 522 applies a biasing force to the cup 516, which, in turn, causes a force F2 to be applied from the SMA pull member 506 to the extension 508 at the contact point 809. Desirably, the force F2 keeps the latch member 502 from pivoting back into the “locked” configuration. By including the SMA pull member 506 (as well as the extension 508 and the flexible arm 522), the SMA-actuated release mechanism 501 can remain in the “unlocked” configuration without having to activate the SMA actuator 514 as the gearbox 531 unwinds. Accordingly, the SMA pull member 506, the extension 508, and the flexible arm 522 can be viewed as a reliability-enhancing coupling mechanism. In particular, inclusion of this coupling mechanism serves to reduce the amount of time that the SMA actuator 514 remains activated, thus increasing the life expectancy of the SMA actuator 514. As with the SMA-actuated release mechanism 501 itself, this coupling mechanism can be viewed as cycling through two configurations or states, namely a “locked” configuration and an “unlocked” configuration. In the illustrated embodiment, the force F2 also serves to push the latch member 502 to an orientation that corresponds to maximal relaxation of stored mechanical energy in the flexible arm 522. At the same time, the SMA pull member 506 reaches an orientation, such that the SMA actuator 514 is stretched to its maximal extent in preparation for its next activation cycle.

Attention next turns to FIG. 9, which illustrates the drive system 500 with the SMA-actuated release mechanism 501 being returned to its “locked” configuration to allow winding of the gearbox 531. In the illustrated embodiment, the SMA-actuated release mechanism 501 can be returned to its “locked” configuration by applying an external stimulus at a contact point 909, such as a push by a human hand. Application of the external stimulus causes the latch member 502 to pivot about the pin 504 along a direction D8. In conjunction, the pawl 520 reengages the activation gear 530, thus preventing unwinding of the gearbox 531. As previously discussed in connection with FIG. 4, the pawl 520 and the activation gear 530 can be configured such that winding of the activation gear 530 along a counter clockwise direction CCW is substantially unimpeded by the pawl 520. As the latch member 502 pivots along the direction D8, the extension 508 contacts the extension 510, which, in turn, causes the SMA pull member 506 to pivot about the pin 505 along the direction D5. In conjunction, the flexible arm 522 engages the cup 516, such that the flexible arm 522 bends. As the external stimulus continues to be applied at the contact point 909, the SMA pull member 506 pivots sufficiently, such that the extensions 508 and 510 are no longer in contact with one another. At that point, mechanical energy stored in the flexible arm 522 is partially released by causing the SMA pull member 506 to reverse its rotation and to be oriented with respect to the latch member 502, such that the extension 510 reengages the extension 508 on the left side of the extension 508.

As discussed previously in connection with FIG. 3 and FIG. 4, the SMA-actuated release mechanism 501 can be configured so to protect the SMA actuator 514 during operation of the drive system 500. For example, referring back to FIG. 8, the SMA-actuated release mechanism 501 can be configured so as to protect the SMA actuator 514 in the event the SMA-actuated release mechanism 501 is inadvertently triggered during unwinding. During such inadvertent triggering or any other triggering, an electric current of limited duration passes through the SMA actuator 514, which causes the SMA actuator 514 to contract. Such contraction of the SMA actuator 514 can cause the SMA pull member 506 to pivot about the pin 505 without bringing the extensions 508 and 510 back into contact. Thus, such inadvertent triggering simply causes the flexible arm 522 to bend and neither overstresses the SMA actuator 514 nor affects unwinding of the gearbox 531. It is contemplated that a controller can be configured to prevent issuance of a pulse of an electric current shortly following a previous pulse of an electric current. In some instances, the controller can be configured to impose a time delay between successive pulses that is comparable in duration to a typical unwinding time of the gearbox 531.

It should be recognized that the embodiments of the invention discussed above are provided by way of example, and various other embodiments are encompassed by the invention. For example, with reference to FIG. 1, it is contemplated that the SMA-actuated release mechanism 101 can include an end-of-travel switch or an on-off switch in place of, or in combination with, the rocker arm member 106 and the bosses 108 and 110. One example of an end-of-travel switch that can be used is described in co-pending U.S. patent application Ser. No. 10/080,640, filed on Feb. 21, 2002, the disclosure of which is incorporated herein by reference in its entirety for all purposes. As such, the power generator 150 can provide an electric current to activate the SMA actuator 114, and the electric current passing through the SMA actuator 114 can be appropriately interrupted by the end-of-travel switch. In particular, the end-of-travel switch can interrupt the electric current once the SMA actuator 114 has contracted up to a certain point, such as up to a point at which the SMA actuator 114 has fully contracted. Typically, an “off” state of the end-of-travel switch can coincide with a configuration in which the pawl 120 becomes disengaged, thus allowing the gearbox 131 to unwind during contraction of the SMA actuator 114 up to the point that defines the “off” state. With no electric current flowing in the “off” state, the SMA actuator 114 extends due to application of a biasing force by the bias spring 122 via the latch member 102. Before the pawl 120 can reengage the gear 134c, the end-of-travel switch can switch to its “on” state, thus allowing uninterrupted unwinding of the gearbox 131. It is contemplated that the end-of-travel switch can allow interruption and resumption of unwinding of the gearbox 131 before reaching a complete discharge point of a drive spring.

The foregoing description, for purposes of explanation, used specific nomenclature to provide a thorough understanding of the invention. However, it will be apparent to one skilled in the art that specific details are not required in order to practice the invention. They are not intended to be exhaustive or to limit the invention to the precise forms disclosed. Many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

1. A shape memory alloy-actuated release mechanism for a drive system, comprising:
at least one anchor point;
a first pivot point;
a latch member pivotally coupled to said first pivot point and configured to engage a drive member of said drive system; and
a shape memory alloy element having a first portion coupled to said at least one anchor point and a second portion coupled to said latch member,
wherein activation of said shape memory alloy element causes said latch member to pivot about said first pivot point, such that said latch member disengages from said drive member.

2. The shape memory alloy-actuated release mechanism of claim 1, wherein deactivation of said shape memory alloy element causes said latch member to pivot about said first pivot point, such that said latch member engages said drive member.

3. The shape memory alloy-actuated release mechanism of claim 1, further comprising:
a second pivot point; and
a pull member pivotally coupled to said second pivot point and configured to engage said latch member,
wherein said second portion of said shape memory alloy element is coupled to said pull member, such that activation of said shape memory alloy element causes said pull member to pivot about said second pivot point and said latch member to pivot about said first pivot point.

4. A drive system, comprising:
a drive mechanism; and
a shape memory alloy-actuated release mechanism coupled to said drive mechanism, said shape memory alloy-actuated release mechanism including:
a latch member configured to engage said drive mechanism; and
a shape memory alloy element coupled to said latch member,
wherein activation of said shape memory alloy element causes movement of said latch member, such that said latch member disengages from said drive mechanism.

5. The drive system of claim 4, wherein deactivation of said shape memory alloy element causes movement of said latch member, such that said latch member engages said drive mechanism.

6. The drive system of claim 4, wherein said shape memory alloy-actuated release mechanism further includes:
at least one anchor point; and
a first pivot point,
wherein said latch member is pivotally coupled to said first pivot point, said shape memory alloy element has a first portion coupled to said at least one anchor point and a second portion coupled to said latch member, and activation of said shape memory alloy element causes said latch member to pivot about said first pivot point, such that said latch member disengages from said drive mechanism.

7. The drive system of claim 6, wherein said shape memory alloy-actuated release mechanism further includes:
a second pivot point; and
a pull member pivotally coupled to said second pivot point and configured to engage said latch member,
wherein said second portion of said shape memory alloy element is coupled to said pull member, such that activation of said shape memory alloy element causes said pull member to pivot about said second pivot point and said latch member to pivot about said first pivot point.
